(19) United States
(12) Patent Application Publication
(10) Pub. No.: US 2026/0346336 A1
(43) Pub. Date: Nov. 5, 2026

(54) METHOD FOR PREPARING SUBMICRON/MICRON PARTICLE REINFORCED REFRACTORY ALLOY BY MEANS OF ELECTRON BEAM SELECTIVE MELTING FORMING

(71) Applicant: AECC BEIJING INSTITUTE OF AERONAUTICAL MATERIALS, Beijing (CN)

(72) Inventors: Wei LIU, Beijing (CN); Huaping XIONG, Beijing (CN); Shuai HUANG, Beijing (CN)

(73) Assignee: AECC BEIJING INSTITUTE OF AERONAUTICAL MATERIALS, Beijing (CN)

(21) Appl. No.: 19/488,632

(22) PCT Filed: Dec. 3, 2024
(86) PCT No.: PCT/CN2024/136386

§ 371 Date: Nov. 28, 2025

(30) Foreign Application Priority Data
Dec. 6, 2023 (CN) 202311667884.1

(51) Int. Cl. B22F 10/28; B22F 1/065; B22F 1/16; B33Y 10/00; B33Y 40/10; B33Y 70/10; C22C 1/05; C22C 27/02

(52) U.S. Cl. CPC B22F 10/28; B22F 1/065; B22F 1/16; B33Y 10/00; B33Y 40/10; B33Y 70/10; C22C 1/05; C22C 27/02; B22F 2301/20; B22F 2302/45; B22F 2304/10; B22F 2998/10; B22F 2999/00

(57) ABSTRACT

A method for preparing a submicron/micron particle reinforced refractory alloy by means of electron beam selective melting forming, comprising steps of: uniformly mixing refractory alloy powder and Si powder, and preparing a submicron/micron particle reinforced refractory alloy by means of an electron beam selective melting forming method. The particle size of the refractory alloy powder is 30-80 μm, and the particle size of the Si powder is 10-25 μm.

This application is a US National Phase application based upon PCT Application No. PCT/CN2024/136386 filed Dec. 3, 2024, which claims the priority of Chinese Patent Application No. 2023116678841, filed with the China National Intellectual Property Administration on Dec. 6, 2023, and titled with “METHOD FOR PREPARING SUBMICRON/MICRON PARTICLE REINFORCED REFRACTORY ALLOY BY MEANS OF ELECTRON BEAM SELECTIVE MELTING FORMING”, which is hereby incorporated by reference in its entirety.

### FIELD

The present disclosure relates to the field of refractory alloy composite material in-situ formation, particularly relates to a method for preparing submicron/micron particle reinforced refractory alloy by electron beam selective melting forming.

### BACKGROUND

Compared with single-phase refractory alloys, the use of particle reinforcement can effectively improve the room-temperature and high-temperature strength of refractory metal-based composite materials. However, it simultaneously causes a significant decrease in plasticity. The contradiction between strength and plasticity has long been a problem in this field, severely restricting the application of refractory alloys in the aerospace and aeronautical industries. Recent research results have shown that as the size of the reinforcing phase decreases, particle-reinforced composite materials exhibit a better balance of comprehensive mechanical properties such as strength and plasticity. At present, relevant studies have been carried out domestically and internationally on particle-reinforced Al, Mg, and Fe based metal composite materials and their preparation methods, and good results have been achieved. In addition, Nb₅Si₃/Nb_{SS} dual-phase composite materials, composed of Nb₅Si₃ reinforcing phase and Nb solid solution, exhibit outstanding high-temperature mechanical properties, with a tensile strength of 370 MPa at 1200 °C, which is twice that of second-generation Ni-based single-crystal alloys. By controlling the microstructural morphology, the fracture toughness can reach over 18 MPa·m^{1/2}. The material has become a research hotspot for next-generation ultra-high-temperature structural materials with a target withstanding temperature of 1200 °C to 1300 °C. It can be inferred that forming a finely dispersed reinforcing particle phase with small particle size formed on a refractory alloy matrix will significantly improve the matching of strength and toughness of refractory alloys.

However, refractory metal composite materials are generally used in high-temperature environments, and the reinforcing phase therein must also possess a high melting point to ensure the high-temperature mechanical performance of the material. Selecting an appropriate secondary-phase particle that forms a well-bonded interface with the refractory alloy matrix while achieving a uniform and dispersed distribution is crucial to obtain refractory alloy composite materials with well-matched properties. Furthermore, due to the inherently high melting points of refractory alloys, it is difficult to prepare by conventional melting and casting techniques, which often resulting in problems such as coarse microstructures and elemental segregation. In particular, when the reinforcing particle size reaches several tens of micrometers, these reinforcing phases tend to become crack initiation sites, which severely influence the mechanical properties of the alloy.

Therefore, selecting appropriate reinforcing phase particles and adopting a suitable process to ensure that the reinforcing phase exhibits fine and dispersed distribution are key issues that urgently need to be solved for developing high-performance refractory alloy composite materials with target operating temperature of 1200 °C to 1300 °C.

### SUMMARY

The purpose of the present disclosure is to provide a method for preparing submicron/micron particle-reinforced refractory alloy by electron beam selective melting forming. The method disclosed in the present disclosure is capable of effectively improving the high-temperature mechanical properties of refractory alloy composite materials and preventing cracking of low-plasticity refractory alloys during the forming process caused by thermal stress.

The present disclosure provides a method for preparing submicron/micron particle-reinforced refractory alloy by electron beam selective melting forming, comprising steps of:
mixing a refractory alloy powder and Si powder uniformly, and preparing a submicron/micron particle-reinforced refractory alloy by electron beam selective melting forming;
wherein the refractory alloy powder has a particle size of 30 μm to 80 μm, and the Si powder has a particle size of 10 μm to 25 μm.

In one embodiment, the refractory alloy powder is an alloy powder consisting of one or two or more of W, Ta, Mo, Nb, V, Zr, Hf, and Ti.

In one embodiment, the refractory alloy powder is spherical powder.

In one embodiment, the refractory alloy is a single-phase solid-solution alloy powder.

In one embodiment, the mass of the Si powder accounts for 1% to 8% of the total mass of the refractory alloy powder and the Si powder.

In one embodiment, during the mixing process, no other solid substance is added and after uniform mixing, a near-spherical composite powder in which a refractory alloy powder is coated with Si powder is obtained.

In one embodiment, the mixing is carried out for a duration of 1 hour to 10 hours.

In one embodiment, during the electron beam selective melting forming process, preheating a powder bed by electron beam scanning with an electron beam power of 300 W to 600 W and an operating voltage of 40 kV to 70 kV.

In one embodiment, the preheating is carried out at a temperature of 800 °C to 1000 °C with a vacuum degree of 2×10⁻³±0.5×10⁻⁴ mbar.

In one embodiment, each powder layer has a thickness of 30 μm to 80 μm.

Compared with the prior art, the present disclosure has the following advantages:
(1) Since refractory metal silicide has excellent high-temperature properties, selecting silicide as the reinforcing phase of the refractory alloy can significantly enhance the high-temperature mechanical properties of the refractory alloy composite material, owing to the extremely high melting point and superior high-temperature mechanical performance of the refractory metal silicide.
(2) A refractory metal silicide is formed in-situ within the refractory alloy matrix under the action of a high-energy electron beam, effectively avoiding interfacial issues between the reinforcing phase and the matrix phase. The two phases exhibit good interfacial bonding, which further ensures the mechanical performance of the refractory alloy composite material.
(3) In the present disclosure, since the Si powder raw material has a particle size of 10 μm to 25 μm and the Nb powder raw material has a particle size of 30 μm to 80 μm, through the in-situ reaction between the refractory alloy and Si and the rapid solidification process under the action of an electron beam, a refractory alloy composite material reinforced with submicron/micron refractory metal silicide particles can be obtained. Compared with the casting refractory alloy of the same components, the particle size of the reinforcing phase can be significantly reduced from tens of micrometers to the submicron/micron scale. Among them, the Nb₅Si₃ reinforcing phase with a submicron size accounts for more than 40% of the total reinforcing phase, thereby greatly reducing the brittleness of the particle-reinforced refractory alloy. Meanwhile, based on the Orowan strengthening mechanism, the strength of the particle-reinforced refractory alloy is significantly improved. This is a remarkable progress in the field.
(4) By employing the electron beam selective melting forming technology, the preparation duration of the refractory alloy composite material can be greatly shortened, and the process has a potential of forming complex structures. Using the above method, a crack-free hollow thin-walled turbine blade with a complex structure for an engine was successfully prepared. The blade part has a good metallurgical quality, and no cracking occurred.
(5) Using the above method, a rectangular bulk material with a size greater than 100×50×50 mm³ was successfully prepared. The room-temperature strength, room-temperature fracture toughness, and high-temperature strength of the alloy were all effectively improved compared with those of the original refractory alloy.

### BRIEF DESCRIPTION OF DRAWINGS

In order to more clearly illustrate the embodiments of the present disclosure or in the prior art, the drawings required for describing the embodiments or the prior art are briefly introduced below. It is obvious that the drawings described below merely represent certain embodiments of the present disclosure.

FIG. 1 is a microstructure of the (NbTiZrHf)₅Si₃ particle-reinforced NbTiZrHf refractory alloy in Example 1 of the present disclosure;

FIG. 2 is a NbTiZrHf refractory alloy hollow turbine blade analog workpiece reinforced with submicron/micron (NbTiZrHf)₅Si₃ particles in Example 1 of the present disclosure;

FIG. 3 is a microstructure of the Nb₅Si₃ particle-reinforced Nb-based refractory alloy in Example 2 of the present disclosure.

### DETAILED DESCRIPTION

The present disclosure provides a method for preparing submicron/micron particle-reinforced refractory alloy by electron beam selective melting forming, comprising steps of:
mixing a refractory alloy powder and Si powder uniformly, and preparing a submicron/micron particle-reinforced refractory alloy by electron beam selective melting forming;
wherein the refractory alloy powder has a particle size of 30 μm to 80μm, and the Si powder has a particle size of 10 μm to 25 μm.

In the present disclosure, the refractory alloy powder is an alloy powder consisting of one or two or more of W, Ta, Mo, Nb, V, Zr, Hf, and Ti. The phase structure of the refractory alloy is a single-phase solid solution. The refractory alloy powder is preferably spherical powder, with a preferred particle size of 30 μm to 80 μm, and more preferably 40 μm to 70 μm, such as 30 μm, 35 μm, 40 μm, 45 μm, 50 μm, 55 μm, 60 μm, 65 μm, 70 μm, 75 μm, and 80 μm. The particle size is preferably within a range defined by any of the above values as an upper or lower limit.

In the present disclosure, the Si powder is in a spherical or irregular shape, and the Si powder preferably has a particle size of 10 μm to 25 μm, and more preferably 15 μm to 20 μm.

In the present disclosure, the mass of the Si powder preferably accounts for 1% to 8% of the total mass of the refractory alloy powder and the Si powder, and more preferably 2% to 7%, such as 1%, 2%, 3%, 4%, 5%, 6%, 7%, and 8%. The mass percentage is preferably within a range defined by any of the above values as an upper or lower limit.

In the present disclosure, the refractory alloy spherical powder and the Si powder are mechanically mixed. No other solid objects (such as grinding balls) are added during the mixing process, so as to maintain the respective particle size ranges of the two powders and to form a near-spherical composite powder in which the refractory alloy powder is coated with small-sized Si powder.

In the present disclosure, the mixing is preferably carried out for a duration of 1 hour to 10 hours, more preferably 3 hours to 8 hours, and most preferably 5 hours to 6 hours.

After the composite powder is obtained, the above composite powder in the present disclosure is used as a raw material powder for electron beam selective melting forming and is loaded into a powder cylinder of an electron beam selective melting forming equipment.

Then, a three-dimensional CAD model of the refractory alloy blade to be prepared is established. The model is subjected to layer-by-layer slicing in the height direction, and each sliced layer is filled with scanning paths. The slicing information and scanning path information are then imported into the electron beam selective melting forming system.

During the forming process, a powder bed is preheated by electron beam scanning. Under the action of the electron beam, the near-spherical composite powder of the refractory alloy +Si is rapidly melted, where the Si element reacts in-situ with part of the refractory alloy to form fine refractory metal silicides, while part of the refractory alloy remains unreacted. Ultimately, a submicron/micron particle-reinforced refractory alloy material or a refractory alloy article with a complex structure is formed.

In the present disclosure, the preheating is preferably carried out at a temperature of 800°C to 1000 °C, more preferably 850 °C to 950 °C, for example, 800 °C, 850 °C, 900 °C, 950 °C, or 1000 °C, preferably within a range defined by any of the above values as an upper or lower limit. The forming process is preferably maintained at a vacuum degree of 2×10⁻3±0.5×10⁻⁴ mbar, more preferably 2×10⁻³±0.4×10⁻⁴ mbar, and most preferably 2×10⁻³±0.3×10⁴ mbar. The operating voltage is preferably 40 kV to 70 kV, more preferably 50 kV to 60 kV, for example, 40 kV, 45 kV, 50 kV, 55 kV, 60 kV, 65 kV, or 70 kV, preferably within a range defined by any of the above values as an upper or lower limit. The electron beam power is preferably set to 300 W to 600 W, more preferably 400 W to 500 W, for example, 300 W, 350 W, 400 W, 450 W, 500 W, 550 W, or 600 W, preferably within a range defined by any of the above values as an upper or lower limit. Each powder layer preferably has a thickness of 30 μm to 80 μm, more preferably 40 μm to 70 μm.

The present disclosure provides a method for preparing a submicron/micron particle-reinforced refractory alloy by electron beam selective melting forming, comprising steps of: mixing a refractory alloy powder and Si powder uniformly, and preparing the submicron/micron particle-reinforced refractory alloy by an electron beam selective melting forming process, wherein refractory alloy powder has a particle size of 30 μm to 80 μm, and the Si powder has a particle size of 10 μm to 25 μm. The present disclosure provides a method in which large-particle-size (30 μm to 80 μm) refractory alloy powder and Si powder with a particle size of 10 μm to 25 μm are mechanically mixed to obtain a near-spherical composite powder of refractory alloy and Si. The resulting composite powder is used as the raw material powder for electron beam selective melting forming. Under the action of a high-energy electron beam, the Si powder in the composite powder reacts in-situ with the refractory alloy powder to form submicron/micron-sized silicides in-situ on the matrix of the refractory alloy. Meanwhile, the rapid scanning of the electron beam achieves preheating during the forming process, thereby preventing cracking of the refractory alloy, which has relatively low plasticity, caused by thermal stress during forming.

In order to further illustrate the present disclosure, the following provides a detailed description of the method for preparing a submicron/micron particle-reinforced refractory alloy by electron beam selective melting forming in conjunction with specific examples, which, however, shall not be construed as limiting the scope of protection of the present disclosure.

### Example 1

A method for preparing a NbTiZrHf refractory alloy hollow turbine blade reinforced with submicron/micron (NbTiZrHf)₅Si₃ particles by electron beam selective melting forming was provided, which was carried out in the following seven steps:
(1) NbTiZrHf refractory alloy powder was prepared by a melting-casting and plasma rotating electrode process, and TiZrHfNb refractory alloy spherical powder with a particle size of approximately 30 μm to 80 μm was obtained through sieving.
(2) TiZrHfNb refractory alloy powder with a particle size of 30μm to 80 μm and Si powder with a particle size of 10 μm to 25 μm were weighed at a mass ratio of approximately 96:4, for a total of 50000 g. Generally, the amount of Si added was calculated based on the Si content required to completely react and form the Nb₅Si₃ reinforcing phase when all Si was consumed.
(3) The 50000 g of mixed powder was loaded into a mixer without adding grinding balls, and was mixed for a total duration of 1 hour to 7 hours.
(4) The above mixed powder was used as the raw material powder for electron beam selective melting forming, and was loaded into a powder cylinder of an electron beam selective melting forming equipment.
(5) The electron beam preheating temperature of the powder bed during selective melting forming was set to 900±50 °C.
(6) A three-dimensional CAD model of the refractory alloy blade to be prepared was established and subjected to layer-by-layer slicing in the height direction, and each sliced layer was filled with a scanning path. The slicing information and scanning path information were then imported into the electron beam selective melting forming system. During forming, the vacuum degree was maintained at 2×10⁻³±0.5×10⁻⁴ mbar, the operating voltage was set at 60 kV, the electron beam power was set at 500 W, and each powder layer had a thickness of 50 μm.
(7) The forming process in the electron beam selective melting forming system was initiated. First, a defocused electron beam was used to preheat the powder bed, causing slight consolidation of the alloy powder. Then, according to the computer-generated path, each powder layer was successively heated, melted and solidified, and the layers were accumulated one by one until the blade was completely prepared.

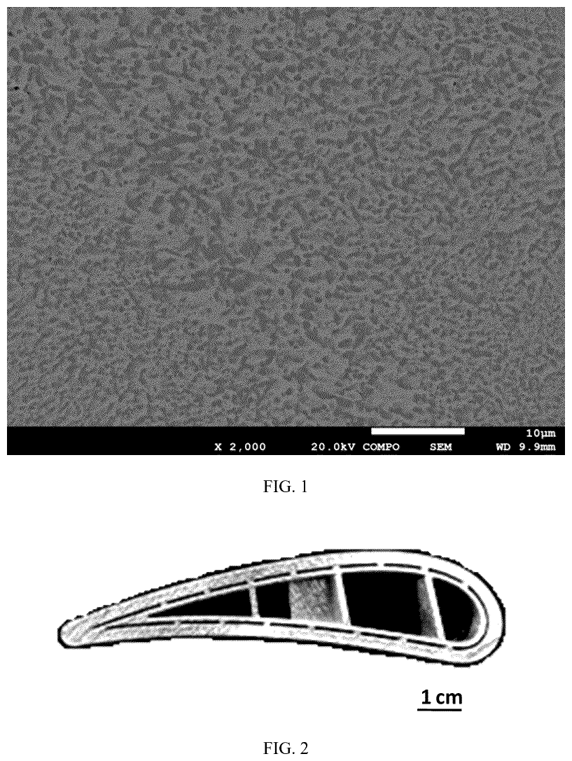

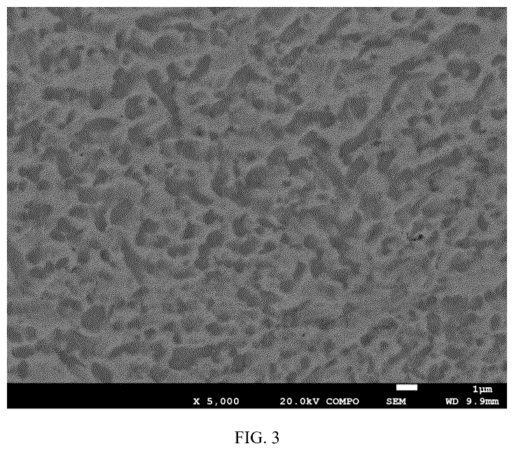

The effects obtained by this example were as follows: the microstructure of the refractory alloy prepared by the present example is shown in FIG. 1. In FIG. 1, the white phase is the TiZrHfNb solid solution phase, while the black phase is the (NbTiZrHf)₅Si₃ refractory metal silicide phase. In the alloy microstructure, most of the (NbTiZrHf)₅Si₃ phases had a size of ≤1 μm, indicating that a submicron/micron particle-reinforced refractory alloy was obtained. Compared with the conventional melting-casting process, this alloy phase effectively reduced the brittleness of the alloy and at the same time improved the strength and toughness of the alloy. FIG. 2 shows a prepared NbTiZrHf refractory alloy hollow turbine blade analog workpiece reinforced with submicron/micron (NbTiZrHf)₅Si₃ particles, which had dimensions of approximately 100 mm (length)×20 mm (width)×80 mm (height). No macroscopic cracks were observed, further demonstrating the competence of the present disclosure in forming and manufacturing complex structures.

### Example 2

A method for preparing a Nb-based refractory alloy reinforced with submicron/micron Nb₅Si₃ particles by electron beam selective melting forming was provided, which was carried out in the following six steps:
(1) Pure Nb refractory alloy powder with a particle size of 30 μm to 80 μm and Si powder with a particle size of 10 μm to 25 μm were weighed at a mass ratio of approximately 95:5, for a total of 10000 g.
(2) The 10000 g of mixed powder was loaded into a mixer, and was mixed for a total duration of 3 hour to 5 hours.
(3) The mixed powder was loaded into a powder cylinder of an electron beam selective melting forming equipment.
(4) The electron beam preheating temperature of the powder bed during selective melting forming was set at 1000±50 °C.
(5) A three-dimensional CAD model of a refractory alloy rectangular block to be prepared with dimensions of 100×50×50 mm³ was established. The model was subjected to layer-by-layer slicing along the 50 mm height direction, and each sliced layer was filled with a scanning path. The slicing information and scanning path information were imported into the electron beam selective melting forming system. The operating voltage was set at 60 kV, the electron beam power was set at 550 W, and each powder layer had a thickness of 50 μm.
(6) The forming process in the electron beam selective melting forming system was initiated. First, a defocused electron beam was used to preheat the powder bed, causing slight consolidation of the alloy powder. Then, according to the computer-generated path, each powder layer was heated, melted and solidified, and the layers were accumulated one by one until the rectangular block of 100×50×50 mm³ was completely prepared.

The effects obtained by this example were as follows: the microstructure of the Nb-Si binary alloy obtained by the example was shown in FIG. 3. In FIG. 3, the white phase is the Nb-based solid solution phase, while the black phase is the NbsSis silicide phase. The Nb₅Si₃ silicide phase exhibited submicron or micron-scale morphology, which effectively reduced the brittleness of the Nb—Si binary alloy while maintaining the high-temperature strength thereof.

The above description are merely some embodiments of the present disclosure. Various modifications and improvements may be made to the present disclosure without departing from its spirit and principle. Such modifications and improvements should be construed as falling within the protection scope of the present disclosure.

1. A method for preparing submicron/micron particle-reinforced refractory alloy by electron beam selective melting forming, comprising steps of:
mixing a refractory alloy powder and Si powder uniformly, and preparing a submicron/micron particle-reinforced refractory alloy by electron beam selective melting forming;
wherein the refractory alloy powder has a particle size of 30 μm to 80 μm, and the Si powder has a particle size of 10 μm to 25 μm.

2. The method according to claim 1, wherein the refractory alloy powder is an alloy powder consisting of one or two or more of W, Ta, Mo, Nb, V, Zr, Hf, and Ti.

3. The method according to claim 2, wherein the refractory alloy powder is spherical powder.

4. The method according to claim 1, wherein the refractory alloy is a single-phase solid-solution alloy powder.

5. The method according to claim 1, wherein the mass of the Si powder accounts for 1% to 8% of the total mass of the refractory alloy powder and the Si powder.

6. The method according to claim 1, wherein during the mixing process, no other solid substance is added and after uniform mixing, a near-spherical composite powder in which a refractory alloy powder is coated with Si powder is obtained.

7. The method according to claim 1, wherein the mixing is carried out for a duration of 1 hour to 10 hours.

8. The method according to claim 1, wherein during the electron beam selective melting forming process, preheating a powder bed by electron beam scanning with an electron beam power of 300 W to 600 W and an operating voltage of 40 kV to 70 kV.

9. The method according to claim 8, wherein the preheating is carried out at a temperature of 800 °C to 1000 °C with a vacuum degree of 2×10⁻³±0.5×10⁻⁴ mbar.

10. The method according to claim 9, wherein each powder layer has a thickness of 30 μm to 80 μm.
